(19) United States
(12) Patent Application Publication
(10) Pub. No.: US 2009/0061317 A1
(43) Pub. Date: Mar. 5, 2009

(54) NEGATIVE ELECTRODE FOR ALKALINE STORAGE BATTERY AND ALKALINE STORAGE BATTERY

(75) Inventors: Tadayoshi TANAKA, Moriguchi City (JP); Yoshifumi MAGARI, Moriguchi City (JP); Shigekazu YASUOKA, Moriguchi City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/200,023

(22) Filed: Aug. 28, 2008

(30) Foreign Application Priority Data
Aug. 28, 2007 (JP) 2007-220591
Dec. 21, 2007 (JP) 2007-329538

(51) Int. Cl. H01M 4/58

(52) U.S. Cl. 429/218.2

(57) ABSTRACT

An alkaline storage battery has a positive electrode, a negative electrode utilizing hydrogen-absorbing alloy, and an alkaline electrolyte, and wherein the negative electrode contains a hydrogen-absorbing alloy represented by the general formula Ln₁₋ₓMgₓNi_{y-a-b}AlₐM_{b}, where Ln is at least an element selected from rare-earth elements including Y and Zr and Ti, M is at least one element selected from V, Nb, Ta, Cr, Mo, Mn, Fe, Co, Ga, Zn, Sn, In, Cu, Si, P and B, 0.05≦x≦0.30, 0.05≦a≦0.30, 0≦b≦0.50 and 2.8≦y≦3.9 and fluorine resins having an average molecular weight of 1,000,000 or less.

### RELATED APPLICATIONS

This application claims priority from Japanese Patent Application Nos. 2007-220591 and 2007-329538, which is hereby incorporated by reference.

### BACKGROUND OF THE INVENTION

1. Field of the Invention

This invention relates to alkaline storage batteries employing positive electrodes, negative electrodes utilizing hydrogen-absorbing alloy, and alkaline electrolytes, and negative electrodes for alkaline storage batteries used in such alkaline storage batteries. More particularly, in an alkaline storage battery using a negative electrode for alkaline storage battery comprising Mg—Ni-rare-earth hydrogen-absorbing alloy and fluorine resins, a feature of the invention is an improvement in the negative electrode for alkaline storage battery for the purpose of suppressing a decrease of discharge capacity or discharge voltage in the case of being left as it is in charged state, and for obtaining an alkaline storage battery with excellent preservation characteristics.

2. Description of the Related Art

Conventionally, nickel-cadmium storage batteries have been commonly used as alkaline storage batteries. In recent years, nickel-hydride storage batteries using a hydrogen-absorbing alloy as their negative electrodes have drawn considerable attention from the viewpoints that they have higher capacity than nickel-cadmium storage batteries and, being free of cadmium, they are more environmentally safe.

As the alkaline storage batteries of nickel-hydride storage batteries have been used in various portable devices and hybrid electric cars, demands for further higher capacity in the nickel-hydride storage batteries have been increasing.

In such alkaline storage batteries, hydrogen-absorbing alloys such as a rare earth-nickel hydrogen-absorbing alloy having a CaCu₅ crystal structure as its main phase and a Laves type hydrogen-absorbing alloy having AB₂ lattice crystal structure as its main phase have been generally used for their negative electrodes.

However, these hydrogen-absorbing alloys generally do not necessarily have sufficient hydrogen-absorbing capability, and it has been difficult to increase the capacity of the alkaline storage batteries further.

In recent years, in order to improve the hydrogen-absorbing capability of the rare earth-nickel hydrogen-absorbing alloy, it has been proposed to use a Mg—Ni-rare earth hydrogen-absorbing alloy having a Ce₂Ni₇ type or a CeNi₃ type crystal structure, rather than the CaCu₅ type, by adding Mg or the like to the rare earth hydrogen-absorbing alloy. (See, for example, Japanese Published Unexamined Patent Application No. 2002-69554.)

Unfortunately, although discharge characteristics under low temperature environments and discharge capacity in high rate discharging are relatively favorable, such a hydrogen-absorbing alloy is easily cracked and its new phase with high reactivity contributes to discharge reaction, and therefore, corrosion resistance is deteriorated and the alkaline storage battery is greatly decreased in its cycle life.

In this connection, it has been conventionally proposed to utilize Mg—Ni-rare earth hydrogen-absorbing alloy incorporating fluorine resins as a negative electrode for alkaline storage battery for proper suppression of penetration of the alkaline electrolyte to the negative electrode. Further, in an alkaline storage battery using such a negative electrode for alkaline storage battery, the above-described hydrogen-absorbing alloy powder is prevented from being turned into fine or being oxidized by charging and discharging, and as a result, its cycle life is improved. (See, for example, Japanese Published Unexamined Patent Application No. 2005-190863.)

Nevertheless, a problem in the above-described alkaline storage battery properly suppressing penetration of the alkaline electrolyte to the negative electrode by adding fluorine resins to the negative electrode has been that satisfied preservation characteristics are not attained and a decrease in discharge capacity and in discharge voltage is caused after being left in charged state.

### SUMMARY OF THE INVENTION

An object of the invention is to solve the above-described problems in the alkaline storage batteries utilizing the hydrogen-absorbing alloy as the negative electrode.

That is, the object of the invention is to prevent decrease of discharge capacity and discharge voltage in the case that an alkaline storage battery utilizing Mg—Ni-rare earth hydrogen-absorbing alloy and fluorine resins as its negative electrode for alkaline storage battery is left in charged state, so that an alkaline storage battery with excellent preservation characteristics can be obtained.

Here, the reason why discharge capacity and discharge voltage are decreased in the case that the alkaline storage battery utilizing Mg—Ni-rare earth hydrogen-absorbing alloy and fluorine resins as its negative electrode for alkaline storage battery is left as it is in charged state, has been investigated.

It is believed that the reason is as follows. In the case where polytetrafluoroethylene having a great average molecular weight of 1,000,000-10,000,000 are used as the fluorine resins, the resins become fibrous, get tangled each other easily and are flocculated among themselves. For this reason, a negative electrode with uniform water repellency can not be obtained. Therefore, the alkaline electrolyte penetrates to the negative electrode, and it becomes impossible to suppress a decrease of the alkaline electrolyte in a separator, as a result, internal resistance of the alkaline storage battery is increased.

The negative electrode for alkaline storage battery of the present invention comprises a hydrogen-absorbing alloy and fluorine resins having an average molecular weight of 1,000,000 or less. The hydrogen-absorbing alloy is represented by the general formula Ln₁₋ₓMgₓNi_{y-a-b}AlₐM_{b}, where Ln is at least an element selected from rare-earth elements including Y and Zr and Ti, M is at least one element selected from V, Nb, Ta, Cr, Mo, Mn, Fe, Co, Ga, Zn, Sn, In, Cu, Si, P and B, 0.05≦x≦0.30, 0.05≦a≦0.30, 0≦b≦0.50 and 2.8≦y≦3.9.

Examples of usable fluorine resins having the average molecular weight of 1,000,000 or less include at least one selected from polytetrafluoroethylene, tetrafluoroethylene-hexafluoropropylene copolymer and tetrafluoroethylene-perfluorovinyl ether copolymer. Particularly, it is preferable to use tetrafluoroethylene-hexafluoropropylene copolymer from viewpoint of easy production of resins having the average molecular weight of 1,000,000 or less.

If the amount of fluorine resins having the average molecular weight of 1,000,000 or less to be added to the negative electrode is small, the alkaline electrolyte penetrates to the negative electrode, and therefore, decrease of the alkaline electrolyte in the separator is not suppressed sufficiently. On the other hand, if the additive amount is too large, the penetration of the alkaline electrolyte to the negative electrode is excessively suppressed, and conductivity as well as charging-discharging reactivity in the negative electrode is deteriorated, leading to degradation of battery characteristics of the alkaline storage battery. For these reasons, it is preferable that the amount of content of resin particles having the average molecular weight of 1,000,000 or less with respect to the amount of the hydrogen-absorbing alloy be within the range of not less than 0.25 weight % to less than 1.0 weight %.

The fluorine resins having the average molecular weight of 1,000,000 or less may be contained in the negative electrode: by applying the fluorine resins on the surface of the negative electrode; or by adding the fluorine resins which are mixed with the hydrogen-absorbing alloy and a binder agent inside of the negative electrode.

The alkaline storage battery according to the present invention uses the above-described negative electrode for alkaline storage battery as its negative electrode.

According to the present invention, the negative electrode for alkaline storage battery using the hydrogen-absorbing alloy represented by the general formula Ln₁₋ₓMgₓNi_{y-a-b}AlₐM_{b}, where Ln is at least an element selected from rare-earth elements including Y and Zr and Ti, M is at least one element selected from V, Nb, Ta, Cr, Mo, Mn, Fe, Co, Ga, Zn, Sn, In, Cu, Si, P and B, 0.05≦x≦0.30, 0.05≦a≦0.30, 0≦b≦0.50 and 2.8≦y≦3.9 contains the fluorine resins having the average molecular weight of 1,000,000 or less. By such ways, the drawbacks that the fluorine resins become fibrous and flocculated in the case of adding polytetrafluoroethylene having a great average molecular weight of 1,000,000-10,000,000 are prevented in the alkaline storage battery of the present invention. Consequently, uniform water repellency is given to the negative electrode, penetration of the alkaline electrolyte to the negative electrode is suppressed, and a decrease of the alkaline electrolyte in the separator is prevented.

As a result, the alkaline storage battery using the above-described negative electrode for alkaline storage battery maintains the alkaline electrolyte in the separator adequately, preventing the internal resistance thereof and suppresses decrease of discharge capacity and discharge voltage in the case of being left in charged state, so that excellent preservation characteristics can be obtained.

These and other objects, advantages and features of the invention will become apparent from the following description thereof taken in conjunction with the accompanying drawings which illustrate specific embodiments of the invention.

### BRIEF DESCRIPTION OF THE DRAWINGS

FIG. 1 is a schematic sectional view showing an alkaline storage battery fabricated in Examples of 1 to 6 and Comparative Examples 1 to 4 of the invention.

### DESCRIPTION OF THE PREFERRED EMBODIMENTS

Hereinbelow, negative electrodes for alkaline storage battery and alkaline storage batteries using the negative electrodes for alkaline storage battery according to embodiments of the invention are specifically described, and it will be demonstrated by the comparison with comparative examples that decrease of discharge capacity and discharge voltage is suppressed in the case of being left in charged state and excellent preservation characteristics are attained in the alkaline storage batteries. It should be construed, however, that the hydrogen-absorbing alloy electrode and the alkaline storage battery according to the invention are not limited to those illustrated in the following embodiments, and various changes and modifications may be made unless such changes and modifications depart from the scope of the invention.

### Example 1

In fabrication of an alkaline storage battery of Example 1, a negative electrode and a positive electrode fabricated in the following manner were used.

### Fabrication of Negative Electrode

A negative electrode was fabricated in the following manner. Nd, Mg, Ni and Al were mixed together to produce a predetermined alloy composition, and the mixture was melted in a high frequency induction melting furnace in argon gas atmosphere and then cooled to prepare hydrogen-absorbing alloy ingots.

Next, the hydrogen-absorbing alloy ingots thus prepared were subjected to a heat treatment in an inert atmosphere for homogenization. Then, the hydrogen-absorbing alloy ingots were mechanically pulverized in the inert atmosphere and classified to obtain a hydrogen-absorbing alloy powder having the composition of Nd_{0.90}Mg_{0.10}Ni_{3.33}Al_{0.17}. This composition of the resultant hydrogen-absorbing alloy powder was analyzed by induction coupling plasma emission spectroanalysis device (ICP). Subsequently, the particle size distribution of the hydrogen-absorbing alloy powder was measured with a laser diffracting/scattering apparatus for measuring particle size, and the average particle size at 50% of a weight integral was found to be 65 μm.

As fluorine resins, ND-4 (made by DAIKIN IND LTD), an available aqueous dispersion of tetrafluoroethylene-hexafluoropropylene copolymer having an average molecular weight of 100,000, that is less than 1,000,000, was used.

Next, 1 part by weight of styrene-butadiene copolymer rubber (SBR), 0.2 parts by weight of polyacrylic acid sodium, 0.2 parts by weight of carboxymethylcellose, 1 part by weight of Ketchen black, 50 parts by weight of water, and the aqueous dispersion of tetrafluoroethylene-hexafluoropropylene copolymer (abbreviated to FEP in the following) with 1 part by weight of solid component FEP were mixed with 100 parts by weight of the hydrogen-absorbing alloy powder to prepare a mixture. Then, the mixture was kneaded in an atmosphere at 25° C. to prepare pastes.

The prepared pastes were applied onto both sides of conductive cores made of punched metal and then dried. The resultant material was cut into predetermined dimensions to prepare a negative electrode. In the negative electrode, the proportion of FEP as the fluorine resins having the average molecular weight of 1,000,000 or less was 1.0 weight % to the hydrogen-absorbing alloy.

### Fabrication of Positive Electrode

A positive electrode was prepared as follows.

Nickel hydroxide powder containing 2.5 weight % of zinc and 1.0 weight % of cobalt was put into an aqueous solution of cobalt sulfate, and 1 mol of aqueous solution of sodium hydroxide was gradually dropped into the mixture with stirring to cause them to react with each other until the pH became 11; thereafter, the resulting precipitate was filtered, washed with water, and vacuum dried. Thus, nickel hydroxide the surface of which was coated with cobalt hydroxide was obtained. The amount of cobalt hydroxide for coating was 5 weight %.

Then, 25 weight % aqueous solution of sodium hydroxide was added and impregnated to the nickel hydroxide the surface of which was coated with cobalt hydroxide, at a weight ratio of 1:10, and the resultant was annealed at 85° C. for 8 hours with stirring. Thereafter, this was washed with water and dried at 65° C., whereby a positive electrode active material was obtained, in which the surface of the nickel hydroxide was coated with sodium-containing higher order cobalt oxide. The valence of cobalt in the cobalt oxide was exceeding divalent.

Then, 95 parts by weight of the positive electrode material thus prepared, 3 parts by weight of zinc oxide, and 2 parts by weight of cobalt hydroxide were mixed together, and 50 parts by weight of an aqueous solution of weight % hydroxypropylcellulose was added to the mixture and mixed together to prepare slurry.

The slurry thus prepared was then filled into a nickel foam having a weight per unit area of about 600 g/m², porosity of 95% and thickness of about 2 mm. The resultant was dried and pressed, and thereafter cut into predetermined dimensions. Thus, a positive electrode composed of non-sintered nickel electrode was prepared.

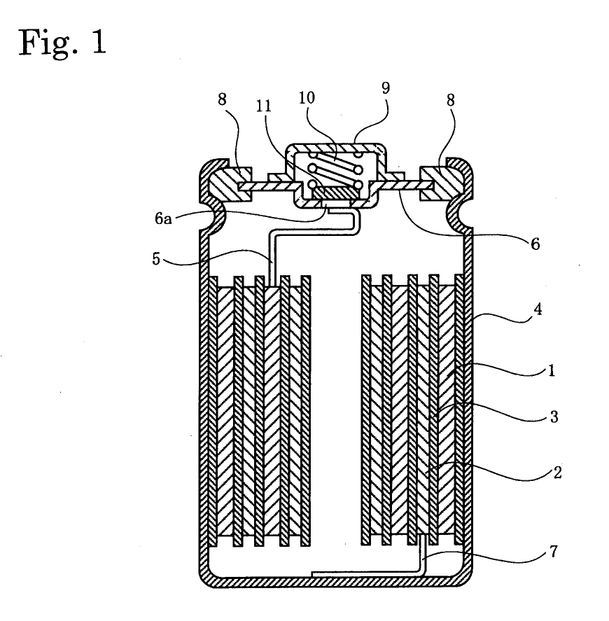

A nonwoven fabric made of polypropylene was used as a separator. An alkaline electrolyte containing KOH, NaOH, and LiOH at a weight ratio of 15:2:1 and having specific gravity of 1.30 was used as an alkaline aqueous solution. Using these components, an alkaline storage battery having a design capacity of 1500 mAh and a cylindrical shape as illustrated in FIG. 1 was fabricated.

The alkaline storage battery was fabricated in the following manner. A positive electrode 1 and a negative electrode 2 were spirally coiled with a separator 3 interposed therebetween, as illustrated in FIG. 1, and these were accommodated in a battery can 4. The positive electrode 1 was connected to a positive electrode cap 6 via a positive electrode lead 5, and the negative electrode 2 was connected to the battery can 4 via a negative electrode lead 7. Then, the alkaline electrolyte was poured into the battery can 4. Thereafter, an insulative packing 8 was placed between the battery can 4 and a positive electrode cap 6, and the battery can 4 was sealed. The battery can 4 and the positive electrode cap 6 were electrically insulated by the insulative packing 8. A blockade plate 11 attached with a coil spring 10 was placed between the positive electrode cap 6 and a positive electrode external terminal 9 to blockade gas releasing hole 6a. The coil spring 10 can be compressed to release gas from the interior of the battery to the atmosphere when the internal pressure of the battery unusually increases.

### Examples 2 to 4

In Examples 2 to 4, alkaline storage batteries of Examples 2 to 4 were fabricated in the same manner as in Example 1 except that the amounts of the solid component of FEP in the aqueous dispersion of FEP to be mixed with 100 parts by weight of the hydrogen-absorbing alloy powder were changed. The weights of solid component FEP to the hydrogen-absorbing alloy powder were as follows; 0.50 weight % in Example 2, 0.25 weight % in Example 3, and 0.10 weight % in Example 4.

### Example 5

In Example 5, the aqueous dispersion of FEP was not used for mixing with 100 parts by weight of the hydrogen-absorbing alloy powder in preparation of a negative electrode. Further, the aqueous dispersion of FEP with 0.60 weight % of solid component FEP mixed with 100 parts by weight of the hydrogen-absorbing alloy powder was applied on the surface of the negative electrode and dried. Except for the above, an alkaline storage battery of Example 5 was fabricated in the same manner as in Example 1.

In Example 6, LDW-410 (made by DAIKIN IND LTD), an aqueous dispersion of polytetrafluoroethylene having an average molecular weight of 1,000,000 or less was used as fluorine resins for preparation of the negative electrode in Example 1.

The aqueous dispersion of polytetrafluoroethylene (abbreviated to PTFE in the following) with 1.0 weight % of solid component PTFE were mixed with 100 parts by weight of the hydrogen-absorbing alloy powder. Except for the above, an alkaline storage battery of Example 6 was fabricated in the same manner as in Example 1.

### Comparative Example 1

In Comparative Example 1, an alkaline storage battery of Comparative Example 1 was fabricated in the same manner as in Example 1 except that the negative electrode wherein the aqueous dispersion of FEP was not used for mixing with 100 parts by weight of the hydrogen-absorbing alloy powder was used.

### Comparative Examples 2 to 4

In Comparative Examples 2 to 4, instead of the aqueous solution of FEP, D1 (made by DAIKIN IND LTD), an aqueous dispersion of PTFE having an average molecular weight of over 1,000,000, that is within the range of more than 1,000,000 to less than 10,000,000, was used as fluorine resins for preparation of the negative electrode in Example 1.

Further, in Comparative Examples 2 to 4, the amounts of the solid component of PTFE in the aqueous dispersion of PTFE to be mixed with 100 parts by weight of the hydrogen-absorbing alloy powder were changed. The weights of solid component PTFE to the hydrogen-absorbing alloy powder were as follows; 0.25 weight % in Comparative Example 2, 0.50 weight % in Comparative Example 3, and 1.0 weight % in Comparative Example 4. Except for the above, alkaline storage batteries of Comparative Examples 2 to 4 were fabricated in the same manner as in Example 1.

Next, the alkaline storage batteries of Examples 1 to 6 and Comparative Examples 1 to 4 were charged at a current of 150 mA for 16 hours and then discharged at a current of 1500 mA until the battery voltage became 1.0 V. This charging and discharging process was repeated three times to activate the alkaline storage batteries of Examples 1 to 6 and Comparative Examples 1 to 4.

Then, each of the alkaline storage batteries of Examples 1 to 6 and Comparative Examples 1 to 4 that were activated in the above-described manner was charged at a current of 1500 mA. After the battery voltage reached the maximum value, each battery was further charged until the voltage lowered 10 mV and discharged at a current of 1500 mA until the battery voltage reached 1.0 V, to measure discharge capacity Qo before being left.

Then, each of the alkaline storage batteries of Examples 1 to 6 and Comparative Examples 1 to 4 was again charged at the current of 1500 mA until the battery voltage reached the maximum value. After that, each battery was further charged until the voltage lowered 10 mV, and with this condition, each battery was left as it was for 7 days in an atmosphere at 60° C. Thereafter, each battery was gotten back under room temperature and was discharged at the current of 1500 mA until the battery voltage became 1.0 V, to measure discharge capacity Qa after being left.

Next, percentage of capacity retention was obtained according to the following equation.

Percentage of capacity retention=(Qa/Qo)×100

Then, with the percentage of capacity retention of Comparative Example 1 being taken as 100, each capacity retention ratio of the above-described alkaline storage batteries was calculated. The results are shown in Table below.

Further, when each of the alkaline storage batteries was discharged at the current of 1500 mA until the battery voltage became 1.0 V as described above, discharge voltage of each alkaline storage battery at a half of its discharge capacity was measured, and increment of the discharge voltage in each alkaline storage battery as against the alkaline storage battery of Comparative Example 1 was determined.

TABLE 1

| | Fluorine resin | | | | | Increment | |
|---|---|---|---|---|---|---|---|
| | | Average | | | Capacity | of | |
| | | molecular | Additive | State of | retention | discharge | |
| | Type | weight | amount | addition | ratio | voltage | |
| Ex. 1 | FEP | 1,000,000 | 1.0 wt % | inside | 106 | +13 | mv |
| | | or less | | | | | |
| Ex. 2 | FEP | 1,000,000 | 0.50 wt % | inside | 104 | +10 | mv |
| | | or less | | | | | |
| Ex. 3 | FEP | 1,000,000 | 0.25 wt % | inside | 104 | +10 | mv |
| | | or less | | | | | |
| Ex. 4 | FEP | 1,000,000 | 0.10 wt % | inside | 101 | +6 | mv |
| | | or less | | | | | |
| Ex. 5 | FEP | 1,000,000 | 0.60 wt % | surface | 106 | +7 | mv |
| | | or less | | | | | |
| Ex. 6 | PTFE | 1,000,000 | 1.0 wt % | inside | 102 | +11 | mv |
| | | or less | | | | | |
| Comp. | — | — | — | — | 100 | 0 | mv |
| Ex. 1 | | | | | | | |
| Comp. | PTFE | over | 0.25 wt % | inside | 98 | +1 | mv |
| Ex. 2 | | 1,000,000 | | | | | |
| Comp. | PTFE | over | 0.50 wt % | inside | 96 | +1 | mv |
| Ex. 3 | | 1,000,000 | | | | | |
| Comp. | PTFE | over | 1.0 wt % | inside | 98 | +3 | mv |
| Ex. 4 | | 1,000,000 | | | | | |

The results demonstrate the following. The alkaline storage batteries of Examples 1 to 6 utilizing FEP and PTFE having the average molecular weight of 1,000,000 or less as fluorine resins to be added to the negative electrode of hydrogen-absorbing alloy, exhibited a greater capacity retention ratio and a greater discharge voltage after being left and more improved preservation characteristics as compared with the alkaline storage battery of Comparative Example 1 which used the negative electrode not containing fluorine resins or the alkaline storage batteries of Comparative Examples 2 to 4 which utilized PTFE having the average molecular weight of over 1,000,000 as fluorine resins.

In addition, a comparison among the alkaline storage batteries of Examples 1 to 6 proves the following. The alkaline storage batteries of Examples 1 to 3 and 5 in which the amounts of fluorine resins of FEP having the average molecular weight of 1,000,000 or less were 0.25 weight % or more, exhibited a greater capacity retention ratio and a greater discharge voltage after being left as compared with the alkaline storage battery of Example 4 in which the amount of fluorine resins was 0.10 weight %. Moreover, the alkaline storage batteries of Examples 1 to 3 and 5 exhibited a greater capacity retention ratio after being left and more improved preservation characteristics as compared with the alkaline storage battery of Example 6 in which the amount of fluorine resins of PTFE having the average molecular weight of 1,000,000 or less was 1.0 weight %. In the alkaline storage battery of Example 5 wherein fluorine resins of FEP were added on the surface of the negative electrode, the same effects as in the case of adding the fluorine resins of FEP the inside of the negative electrode were obtained.

Next, each of the alkaline storage batteries of Examples 1 to 4 and Comparative Example 1 that were activated in the above-described manner was charged at a current of 1500 mA. After the battery voltage reached the maximum value, each battery was further charged until the voltage lowered 10 mV and thereafter discharged at a high current of 6000 mA until the battery voltage reached 1.0 V. Next, high-rate discharge capacity of each alkaline storage battery of Examples 1 to 4 and Comparative Example 1 was measured. Then, with the high-rate discharge capacity of Comparative Example 1 being taken as 100, each high-rate discharge performance ratio of the above-described alkaline storage batteries was calculated. The results are shown in Table 2 below.

TABLE 2

| | Fluorine resin | | | | High-rate |
|---|---|---|---|---|---|
| | | Average | | | discharge |
| | | molecular | Additive | State of | performance |
| | Type | weight | amount | addition | ratio |
| Ex. 1 | FEP | 1,000,000 | 1.0 wt % | inside | 89 |
| | | or less | | | |
| Ex. 2 | FEP | 1,000,000 | 0.50 wt % | inside | 96 |
| | | or less | | | |
| Ex. 3 | FEP | 1,000,000 | 0.25 wt % | inside | 98 |
| | | or less | | | |
| Ex. 4 | FEP | 1,000,000 | 0.10 wt % | inside | 98 |
| | | or less | | | |
| Comp. | — | — | — | — | 100 |
| Ex. 1 | | | | | |

As a result, the high-rate discharge performance ratio of the alkaline storage battery of Example 1 in which the amount of fluorine resins of FEP having the average molecular weight of 1,000,000 or less was 1.0 weight %, was lower than that of each alkaline storage battery in which the amount of fluorine resins was lower than 1.00 weight %.

Accordingly, in order to obtain an alkaline storage battery with improved high-rate discharge performance, it is preferable that the amount of fluorine resins having an average molecular weight of 1,000,000 or less be less than 1.0 weight % with respect to the hydrogen-absorbing alloy.

Although the present invention has been fully described by way of examples, it is to be noted that various changes and modifications will be apparent to those skilled in the art.

Therefore, unless otherwise such changes and modifications depart from the scope of the present invention, they should be construed as being included therein.

What is claimed is:

1. A negative electrode for alkaline storage battery comprising:
a hydrogen-absorbing alloy represented by the general formula Ln₁₋ₓMgₓNi_{y-a-b}AlₐM_{b}, where Ln is at least an element selected from rare-earth elements including Y and Zr and Ti, M is at least one element selected from V, Nb, Ta, Cr, Mo, Mn, Fe, Co, Ga, Zn, Sn, In, Cu, Si, P and B, 0.05≦x≦0.30, 0.05≦a≦0.30, 0≦b≦0.50 and 2.8≦y≦3.9;
and fluorine resins having an average molecular weight of 1,000,000 or less.

2. The negative electrode for alkaline storage battery as claimed in claim 1,
wherein the fluorine resins having the average molecular weight of 1,000,000 or less are at least one type selected from polytetrafluoroethylene, tetrafluoroethylene-hexafluoropropylene copolymer and tetrafluoroethylene-perfluorovinyl ether copolymer.

3. The negative electrode for alkaline storage battery as claimed in claim 1,
wherein the fluorine resins having the average molecular weight of 1,000,000 or less are tetrafluoroethylene-hexafluoropropylene copolymer.

4. The negative electrode for alkaline storage battery as claimed in claim 1,
wherein the amount of the fluorine resins having the average molecular weight of 1,000,000 or less with respect to the hydrogen-absorbing alloy is within the range of not less than 0.25 weight % to less than 1.0 weight %.

5. The negative electrode for alkaline storage battery as claimed in claim 1,
wherein the fluorine resins having the average molecular weight of 1,000,000 or less exist inside of the negative electrode.

6. The negative electrode for alkaline storage battery as claimed in claim 1,
wherein the fluorine resins having the average molecular weight of 1,000,000 or less exist on the surface of the negative electrode.

7. An alkaline storage battery employing:
a positive electrode; a negative electrode utilizing hydrogen-absorbing alloy; and an alkaline electrolyte;
wherein the negative electrode is the negative electrode for alkaline storage battery of claim 1.

8. An alkaline storage battery employing:
a positive electrode; a negative electrode utilizing hydrogen-absorbing alloy; and an alkaline electrolyte;
wherein the negative electrode is the negative electrode for alkaline storage battery of claim 2.

9. An alkaline storage battery employing:
a positive electrode; a negative electrode utilizing hydrogen-absorbing alloy; and an alkaline electrolyte;
wherein the negative electrode is the negative electrode for alkaline storage battery of claim 3.

10. An alkaline storage battery employing:
a positive electrode; a negative electrode utilizing hydrogen-absorbing alloy; and an alkaline electrolyte;
wherein the negative electrode is the negative electrode for alkaline storage battery of claim 4.

11. An alkaline storage battery employing:
a positive electrode; a negative electrode utilizing hydrogen-absorbing alloy; and an alkaline electrolyte;
wherein the negative electrode is the negative electrode for alkaline storage battery of claim 5.

12. An alkaline storage battery employing:
a positive electrode; a negative electrode utilizing hydrogen-absorbing alloy; and an alkaline electrolyte;
wherein the negative electrode is the negative electrode for alkaline storage battery of claim 6.
